(19) United States
(12) Patent Application Publication
(10) Pub. No.: US 2002/0125848 A1
(43) Pub. Date: Sep. 12, 2002

(54) Circuit for power supply of several reversible electrical actuators

(75) Inventors: Stefan Schober, Heilbronn (DE); Walter Lutzenberger, Pocking (DE)

Correspondence Address: NIXON PEABODY, LLP, 8180 GREENSBORO DRIVE, SUITE 800, MCLEAN, VA, 22102, US

(73) Assignee: Webasto Vehicle Systems International GmbH, Stockdorf (DE)

(21) Appl. No.: 09/993,881

(22) Filed: Nov. 27, 2001

(30) Foreign Application Priority Data
Nov. 24, 2000 (DE) 100 58 549.3

(51) Int. Cl. G05B 11/32

(52) U.S. Cl. 318/625

(57) ABSTRACT

A circuit for the supplying power to at least three electric servomotors, such as servomotors used for an openable motor vehicle roof, each electric servomotor having a first terminal and a second terminal. The circuit includes a power supply, such as a voltage source having a first pole and a second pole, four independently actuable changeover contacts for individually activating and reversing the electric servomotors, whereby a pair of the changeover contacts are connected respectively to the first and second poles of the voltage source. A pair of the changeover contacts are assigned respectively to two of the at least three electric servomotors, and the first terminal of the first servomotor is connected to the first terminal of the third servomotor and the second terminal of the second servomotor is connected to a second terminal of the third servomotor.

### BACKGROUND OF THE INVENTION

1. Field of the Invention

This invention relates to a circuit for the power supply of a plurality of reversible electrical servomotors, such as servomotors for an openable motor vehicle roof, the servomotors including a power source and a circuit connectable to the power source for actuating the servomotors.

2. Description of the Related Art

Circuits of the initially mentioned type are used, for example, in motor vehicles for triggering a plurality of electric servomotors for moving an openable motor vehicle roof or for adjusting the position of one of the vehicle seats. Since several movable parts must be shifted along different adjustment paths, in such a case there are two or more electrical servomotors, for example, to move a cover or the wind deflector of a motor vehicle roof individually or to adjust a motor vehicle seat with respect to its position in the lengthwise direction of the vehicle, its height, seat inclination and tilt of the backrest.

Since provisions must be made to enable the activation of these servomotors individually, and for each servomotor an operating position for designating as “Counterclockwise”, “Clockwise” and “Off” must be implemented, in the known circuits of the initially mentioned type it has been proposed that for each of the servomotors there be a circuit having two independently actuable changeover contacts to implement the indicated operating states.

One such circuit is disclosed in German Patent Application DE 197 06 297 A1, in which a control device for a motor vehicle seat is described. To adjust the position in the lengthwise direction of the motor vehicle, the vertical position and the incline of the back of the motor vehicle seat, there are three servomotors which can be actuated independently of one another in both directions of motor rotation via two changeover contacts which can be activated independently. If the servomotors are variable-speed servomotors, the activation of each of the servomotors has a pulse duration modulation arrangement in addition to the indicated circuit.

Furthermore, Japanese Patent Publication JP 11332290 A discloses a circuit for the power supply of four reversible electrical servomotors, the circuit having a power source and a circuit for actuating the actuators, the circuit having four independently actuable changeover contacts by way of which the electrical actuators can be activated and reversed individually.

Japanese Patent Publication JP 62-85695 discloses a motor control circuit for a camera in which three reversible electrical servomotors are activated by way of bridge circuits which are composed of transistors and which prevent simultaneous operation of the motors. To reduce the number of transistors used, it is disclosed that two motors at a time share the transistors of one bridge.

German Patent Application DE 44 29 998 A1 describes an arrangement for the position control of electric motors, which are used for activation of electrically adjustable motor vehicle seats. To reduce the circuit complexity, it is suggested that a common circuit for monitoring the angle of rotation be provided. There can be a pulse duration modulation arrangement for controlled activation of the electric motors.

German Patent Publication DE 38 29 405 C2 discloses an actuating means for parts of motor vehicles that are moved by electric motors, in which the direction in which the servomotor turns is controlled by two relays and their changeover contacts.

### SUMMARY OF THE INVENTION

The primary object of the invention is to devise a circuit of the initially mentioned type which has a simple structure and which can be more economically produced than existing circuits for power supply of at least three reversible electric servomotors.

This object is achieved in accordance with the invention by providing a circuit for the power supply of at least three electric servomotors, such as those for an openable motor vehicle roof, each servomotor having a first terminal and a second terminal. The circuit is provided with a voltage source having a first pole and a second pole and four independently actuable changeover contacts, whereby the electric servomotors can be activated and reversed individually. A changeover contact is provided for each servomotor for connection to the first pole and to the second pole are assigned to each terminal of a first servomotor and each terminal of a second servomotor, the first terminal of the first servomotor being connected to the first terminal of the third servomotor and the second terminal of the second servomotor being connected to a second terminal of the third servomotor.

Thus, since the servomotors “share” the changeover contacts, instead of each servomotor having its own pair of changeover contacts, in this way the number of components necessary for individual activation and reversing is reduced.

The circuit proposed here is suitable not only for the indicated use for adjusting a motor vehicle seat, but also for use in openable motor vehicle roofs with at least one roof opening in a fixed motor vehicle roof and at least two electrically driven cover elements for closing and partially clearing at least one roof opening. Here, the electrical servomotors for adjusting the cover elements can also be connected for adjusting a wind deflector.

Examples of motor vehicle roofs in which there can be several independently actuable servomotors are multi-cover roofs with several independently movable cover elements or louvered roofs which can be selectively opened proceeding from the front or rear edge of the roof opening. Furthermore, the concept described here is also suitable for those louvered roofs in which there is a servomotor for moving the louvers in the lengthwise direction of the motor vehicle and another servomotor for raising at least one of the louvers. In addition, each roof can additionally be provided with wind deflectors which can be moved independently of one another.

One preferred embodiment of the invention is explained in detailed below with reference to the attached drawings.

### BRIEF DESCRIPTION OF THE DRAWINGS

FIG. 1 shows a schematic sectional view of a motor vehicle roof with three cover elements which can be moved independently of one another; and

FIG. 2 shows a connection diagram of a circuit in accordance with the invention.

### DETAILED DESCRIPTION OF THE INVENTION

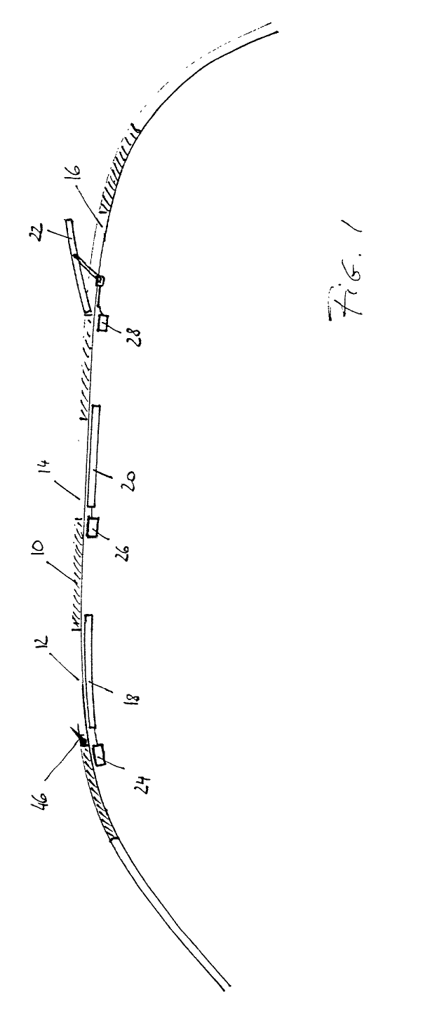

In the motor vehicle roof shown schematically in FIG. 1, a fixed roof surface 10 is provided having three roof openings 12, 14, 16 which can be selectively closed or at least partially cleared by way of cover elements 18, 20, 22 which can be moved independently of one another. Furthermore, in the front roof opening 12 there is a wind deflector 46 which can be driven by way of its own servomotor (not shown). To move the individual cover elements 18, 20, 22, there is one reversible electric servomotor 24, 26, 28 for each cover element 18, 20, 22 which provides for moving the cover elements 18, 20, 22 selectively in the opening or closing direction via a mechanism which is not detailed. In the example shown in FIG. 1, the front cover element 18 and the middle cover element 20 are designed as elements which can be moved in the lengthwise direction of the vehicle, while the rear cover element 22 is designed as an element which can be raised above the fixed roof surface 10.

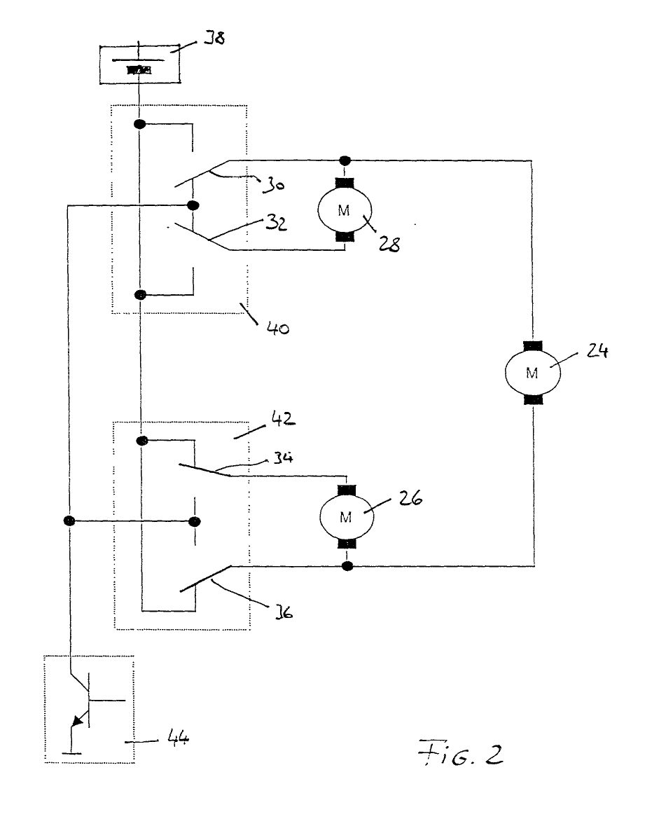

To independently activate the cover elements 18, 20, 22, there is a circuit as shown in FIG. 2. The three electrical servomotors 24, 26, 28 are connected to the power supply such as a battery 38 of the motor vehicle via a circuit which comprises four independently actuable changeover contacts 30, 32, 34, 36 and an actuating arrangement (not shown) for switching the changeover contacts 30, 32, 34, 36. As shown in FIG. 2, the changeover contacts 30, 32, 34, 36 can be combined in pairs in a relay 40, 42. If the electrical servomotors 24, 26, 28 are designed as variable-speed drives, there is preferably a single pulse duration modulation arrangement 44 which is jointly used by all three servomotors 24, 26, 28. Preferably, the pulse duration modulation arrangement 44 encompasses a solid-state power switch.

The changeover contacts 30, 32, 34, 36 can be moved into a top and bottom position individually and independently of one another. The possible operating states of the circuit shown in FIG. 2 are summarized in the following table.

Operating states of the circuit as shown in Figure 2

| | Contact | Contact | Contact | Contact | Motor | Motor | Motor |
|---|---|---|---|---|---|---|---|
| No. | 30 | 32 | 34 | 36 | 24 | 26 | 28 |
| 1 | Down | Up | Up | Down | R | — | — |
| 2 | Up | Down | Down | Up | L | — | — |
| 3 | Up | Down | Down | Down | — | R | — |
| 4 | Down | Up | Up | Up | — | L | — |
| 5 | Down | Down | Down | Up | — | — | R |
| 6 | Up | Up | Up | Down | — | — | L |
| 7 | Down | Up | Down | Down | R | R | — |
| 8 | Up | Down | Up | Up | L | L | — |
| 9 | Down | Down | Up | Down | R | — | R |
| 10 | Up | Up | Down | Up | L | — | L |
| 11 | Down | Down | Down | Down | R | R | R |
| 12 | Up | Up | Up | Up | L | L | L |
| 13 | Up | Down | Up | Down | — | — | — |
| 14 | Down | Up | Down | Up | — | — | — |
| 15 | Up | Up | Down | Down | — | R | L |
| 16 | Down | Down | Up | Up | — | L | R |

R: clockwise
L: counterclockwise
—: off

If the changeover contacts 30, 32, 34 and 36 are in the positions labeled operating state no. 1 in the table, this being the operating state of the circuit shown in FIG. 2, current flows from the positive pole of the motor vehicle battery 38 via the contact 36 through the motor 24 and via the contact 30 to the frame terminal which is indicated in FIG. 2 within the pulse duration modulation arrangement 44. In the table, this mode of operation of the motor 24 is called Clockwise (R). Since in operating state no. 1 the two contacts of the motor 26 are connected to the positive pole of the motor vehicle battery 38, while the two contacts of the motor 26 are connected to ground via the pulse duration modulation arrangement 44, the motors 26, 28 are not operated in the operating state no. 1, i.e., in an “Off” position.

If, conversely, the changeover contacts 30, 32, 34, 36 are moved into the positions labeled in the table as operating state no. 2, a current flows from the positive pole of the motor vehicle battery 38 via the contact 30 through the motor 24 and via the contact 36 to the frame terminal. This mode of operation of the motor 24 is labeled Counterclockwise (L) in the table. In operating state no. 2, the motors 26 and 28 are not operated, i.e., are “Off”, since the two contacts of the motor 28 are connected to ground while the two contacts of the motor 28 are connected to the positive pole of the motor vehicle battery 38.

As is apparent from the aforementioned table, in the circuit being explained, the motors 24, 26, 28 cannot only all be operated individually in Clockwise and in Counterclockwise positions (operating states 1 to 6), but several motors can also be activated in a specific manner at the same time. In particular, the front 12 and the middle 14 cover elements can be open or closed at the same time by way of operating states 7 and 8, the front 12 and the rear 16 cover elements at the same time by way of the operating states 9 and 10. Moreover, through the operating states 11 and 12, simultaneous opening or closing of all cover elements 12, 14, 16 is possible; this can be used in a roof with multiple covers as a quick closing feature. In operating states 13 and 14, all motors are in an “Off” state, in operating states 15 and 16, the motors 26, 28 are operated in opposite directions.

It goes without saying that the actuation arrangement (not shown) for switching the changeover contacts 30, 32, 34, 36 need not all be able to implement all the operating states listed in the table. If, for example, purely sequential operation of the motors 24, 26, 28 according to the arrangement in FIG. 2 is desired, the actuation arrangement for switching the changeover contacts 30, 32, 34, 36 could be designed such that it can cause operating states 1 to 6 and 13, while the other operating states given in the table are abandoned.

What is claimed is:

1. Circuit for supplying power to at least three electric servomotors for an openable motor vehicle roof, each electric servomotor having a first terminal and a second terminal, the circuit comprising:
a voltage source having a first pole and a second pole;
four independently actuable changeover contacts for individually activating and reversing the at least three electric servomotors, a pair of said changeover contacts being connected respectively to said first pole and said second pole of said voltage source,
wherein said pair of said changeover contacts are assigned respectively to two of the at least three electric servomotors, the first terminal of the first servomotor being connected to the first terminal of the third servomotor and the second terminal of the second servomotor being connected to a second terminal of the third servomotor.

2. Circuit as claimed in claim 1, wherein at least two of said four independently actuable changeover contacts are combined into a single relay.

3. Circuit as claimed in one of claims 1, wherein at least two of said at least three electric servomotors are variable-speed.

4. Circuit as claimed in one of claims 3, further comprising a pulse duration modulation arrangement for a variable-speed activation of said at least two electric servomotors.

5. Circuit as claimed in claim 4, wherein said pulse duration modulation arrangement includes a solid-state power switch.

6. Openable motor vehicle roof comprising:
a fixed motor vehicle roof having at least one roof opening and at least two cover elements for closing and partially clearing at least one roof opening;
at least three electric servomotors for driving said at least two cover elements, each of said at least three electric servomotors having a first terminal and a second terminal;
a circuit for connection to said at least three electric servomotors, said circuit including a voltage source having a first pole and a second pole, four independently actuable changeover contacts for individually activating and reversing the at least three electric servomotors, wherein a pair of said changeover contacts are connected respectively to said first pole and said second pole of said voltage source,
wherein said pair of said changeover contacts are assigned respectively to two of said at least three electric servomotors, the first terminal of the first servomotor being connected to the first terminal of the third servomotor and the second terminal of the second servomotor being connected to a second terminal of the third servomotor.

7. Motor vehicle roof as claimed in claim 6, further comprising a wind deflector connectable to one of said at least three electric servomotors for selective movement relative to said fixed motor vehicle roof.

8. Motor vehicle roof as claimed in claim 6, wherein said at least two cover elements are part of a louvered roof.

9. Motor vehicle roof as claimed in claim 6, wherein said at least two cover elements are part of a folding roof.

10. Motor vehicle roof as claimed in claim 6, wherein said at least three electric servomotors are adapted to drive at least one of pivoting and slidable side members.
